(19) United States
(12) Patent Application Publication
(10) Pub. No.: US 2016/0116334 A1
(43) Pub. Date: Apr. 28, 2016

(54) MULTI-WELL PLATE FOR USE IN RAMAN SPECTROSCOPY

(71) Applicants: Frank Jiann-Fu Yang, Vista, CA (US); Ke-Yi Wang, Taichung City (TW)

(72) Inventors: Frank Jiann-Fu Yang, Vista, CA (US); Ke-Yi Wang, Taichung City (TW)

(21) Appl. No.: 14/526,492

(22) Filed: Oct. 28, 2014

(51) Int. Cl. G01J 3/02; G01J 3/44

(52) U.S. Cl. CPC G01J 3/0205; G01J 3/4412

(57) ABSTRACT

A multi-well plate for use in Raman spectroscopy includes a substrate and a metallic layer. The substrate defines a plurality of wells in a top surface thereof. The metallic layer is disposed on a bottom wall of each of the wells in the substrate. The substrate may comprise a material selected from the group consisting of glass and plastic. Each of the wells in the substrate has a diameter of about 0.02 to 10 mm and a depth of about 0.1 to 5 mm above the metallic layer for reception of about a droplet of an analyte

### BACKGROUND OF THE INVENTION

1. Field of the Invention

The present invention relates to a multi-well plate, and more particularly to a multi-well plate for use in Raman spectroscopy.

2. Description of the Related Art

Raman spectroscopy is a well-known technique for chemical trace analysis. In the practice of Raman spectroscopy, the beam from a light source, generally a laser, is focused upon an analyte to thereby generate inelastically scattered radiation, which is optically collected and directed into a wavelength-dispersive spectrometer in which a detector converts the energy of impinging photons to electrical signal intensity. Similar to an infrared spectrum, a Raman spectrum consists of a wavelength distribution of bands corresponding to molecular vibrations specific to the sample being analyzed and therefore gives a series of sharp lines which constitute a unique fingerprint of a molecule.

However, molecular Raman scattering of photons is a weak process. Surface enhanced Raman spectroscopy (SERS) is a technique that allows for generation of a stronger Raman signal from an analyte relative to conventional Raman spectroscopy. In SERS, Raman signals are magnified by a million to a trillion times compared with the signal from a bulk sample. SERS takes place only when molecules are adsorbed to a conductive surface that isn't flat on a microscopic scale. The effect is the result of an increase in the local optical field that arises from the sharp points of textured metals such as gold, silver or copper. When a laser beam of the right wavelength strikes the metal substrate, it generates surface plasmons, which assist in delivering light to the molecule and in getting out the resulting Raman signal.

The key to SERS is the substrate, and a reproducible, commercially available glass-mounted SERS substrate 900 is shown in FIG. 8. The active area 90 for this surface-enhanced Raman spectroscopy (SERS) substrate 900 is a middle square in the golden SERS chip 9. A sample or analyte is to be placed atop the active area 90 and then analyzed using Raman spectroscopy equipment. However, it is understood that this glass-mounted SERS substrate 900 is expensive and require a long length of time for drying process and can hardly be employed for Raman spectroscopy measurements at a large number of samples in routine applications.

### SUMMARY OF THE INVENTION

Accordingly, it is an object of the present invention to provide an improved sample holder or multi-well plate for use in Raman spectroscopy.

It is another object of the present invention to provide a multi-well plate that can be produced in a cost effective manner and be used for Raman spectroscopy measurements at a large number of sample scale.

The multi-well plate embodying the present invention includes a substrate defining a plurality of wells therein, and a metallic layer disposed on a bottom wall of each of the wells in the substrate. The substrate may be made of a material selected from the group consisting of glass, plastic, and quartz. The metallic layer may be a SERS-active metal capable of exhibiting a surface enhancement of Raman scattering of an analyte located in each well of the substrate. Preferably, each of the wells in the substrate has a diameter of about 0.02 to 10 mm and a depth of about 0.1 to 5.0 mm above the metallic layer for reception of about a droplet of an analyte.

The metallic layer may also be a SERS-active layer that comprises an array of nanostructures thereon. Alternatively, the metallic layer may include a metal selected from the group consisting of aluminum, stainless steel, copper, chromium and iron. The metallic layer may be deposited or plated or just detachably placed on the bottom wall of each of the wells in the substrate.

Another aspect of the present invention is to provide a Raman spectroscopy measurement system that is equipped with the aforementioned multi-well plate. Other objects and advantages of the present invention will become apparent from the following detailed description.

### BRIEF DESCRIPTION OF THE DRAWINGS

FIG. 1 is a perspective view of a multi-well plate for use in Raman spectroscopy in accordance with one embodiment of the present invention;

FIG. 2 is a cross-sectional view of the multi-well plate, taken along the line II-II in FIG. 1;

FIG. 3 is a view similar to FIG. 2, showing that a droplet of analyte is on the way to be filled into a well of the plate;

FIG. 4 is a view similar to FIG. 2, showing that the droplet of analyte is filled in the well of the plate;

FIG. 5 is a perspective view of a multi-well plate for use in Raman spectroscopy in accordance with another embodiment of the present invention;

FIG. 6 is a cross-sectional view of the multi-well plate shown in FIG. 5 and the analytes filled in the wells of the plate;

FIG. 7 is a block diagram schematically illustrating a Raman spectroscopy measurement system embodying the present invention; and

FIG. 8 is a prior art.

### DETAILED DESCRIPTION OF EMBODIMENTS

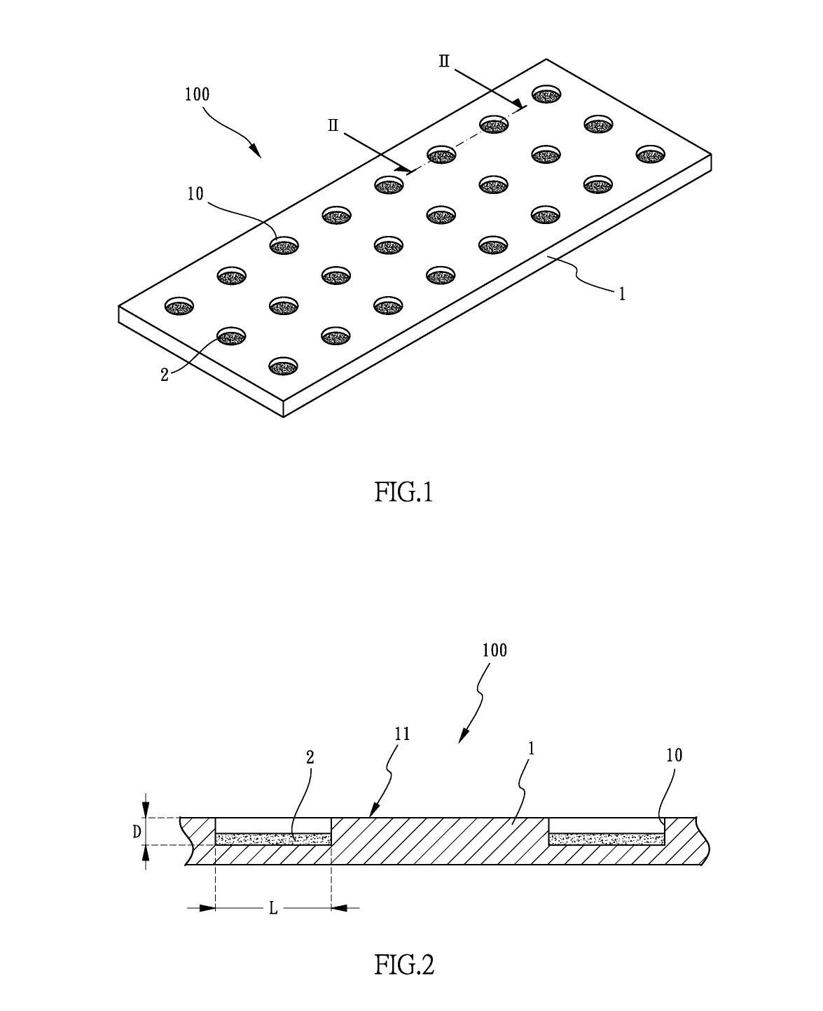

Referring to FIGS. 1 and 2, there is shown an embodiment of the multi-well plate 100 for use in Raman spectroscopy. The multi-well plate 100 includes a substrate 1 defining a plurality of wells 10 therein, and a metallic layer 2 disposed on a bottom wall of each of the wells 10 in the substrate 1.

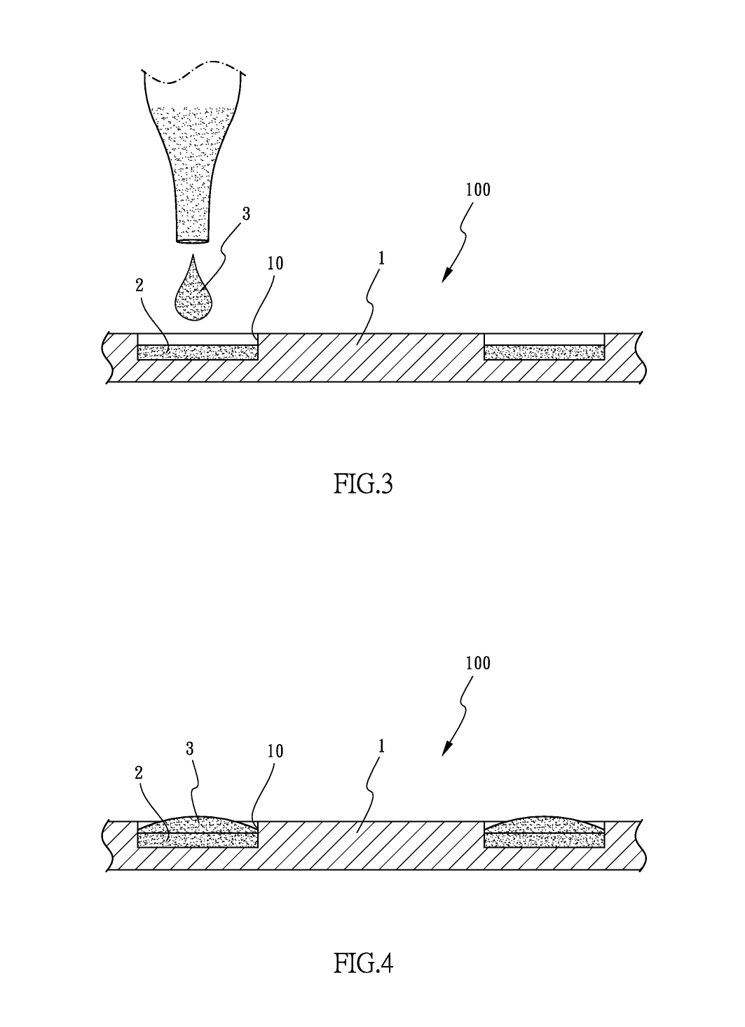

As best seen in FIG. 2, each of the wells 10 is recessed from a top surface 11 of the substrate 1 and into the substrate 1. The substrate 1 may be made of glass or molded from plastic, for cost concerns. Each of the wells 10 in the substrate 1 has a diameter L of about 2 to 5 mm and a depth D of about 1 mm above the metallic layer 2 for reception of about a droplet of an analyte 3, as depicted in FIGS. 3 and 4.

The metallic layer 2 may be made from commonly used metal, such as aluminum, stainless steel, copper, chromium and iron. The selected metal material may be deposited or electroplated on the bottom wall of each of the wells 10 in the substrate 1 to form the metallic layer 2. Alternatively, the metallic layer 2 may be a piece of metal sheet that is cut into a desired size and shape, and then be placed on the bottom wall of each of the wells 10 in the substrate 1. Preferably, the metallic layer 2 is surface-enhanced Raman scattering (SERS)-active. For example, the metallic layer 2 may include any SERS-active material such as, gold, silver, copper, platinum, palladium, aluminum, nickel, chromium, cadmium, iron or any other material that will enhance the Raman scattering of photons by the analyte molecules positioned adjacent thereto. It has been found that most of the SERS-active materials are transition metals. Alternatively, the metallic layer 2 may be a SERS-active layer that comprises an array of semiconductor nanostructures thereon.

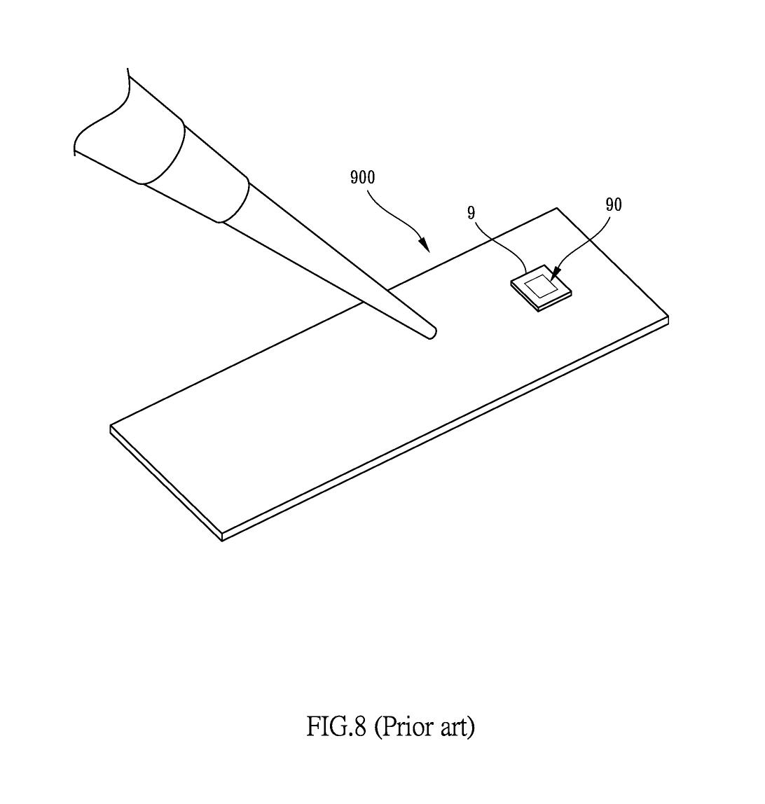

Unlike the prior art glass-mounted SERS substrate 900 of FIG. 8, the multi-well plate 100 can receive a plurality of analytes 3 to be analyzed at a time, and each droplet of the analytes 3 may be exactly centered in the respective wells 10 of the plate 100. In this manner, a laser beam may be more easily focused and correctly strikes on each of the analytes 3 in the multi-well plate 100 to generate Raman scattering so that the Raman Spectroscopy measurements may be performed at a large scale.

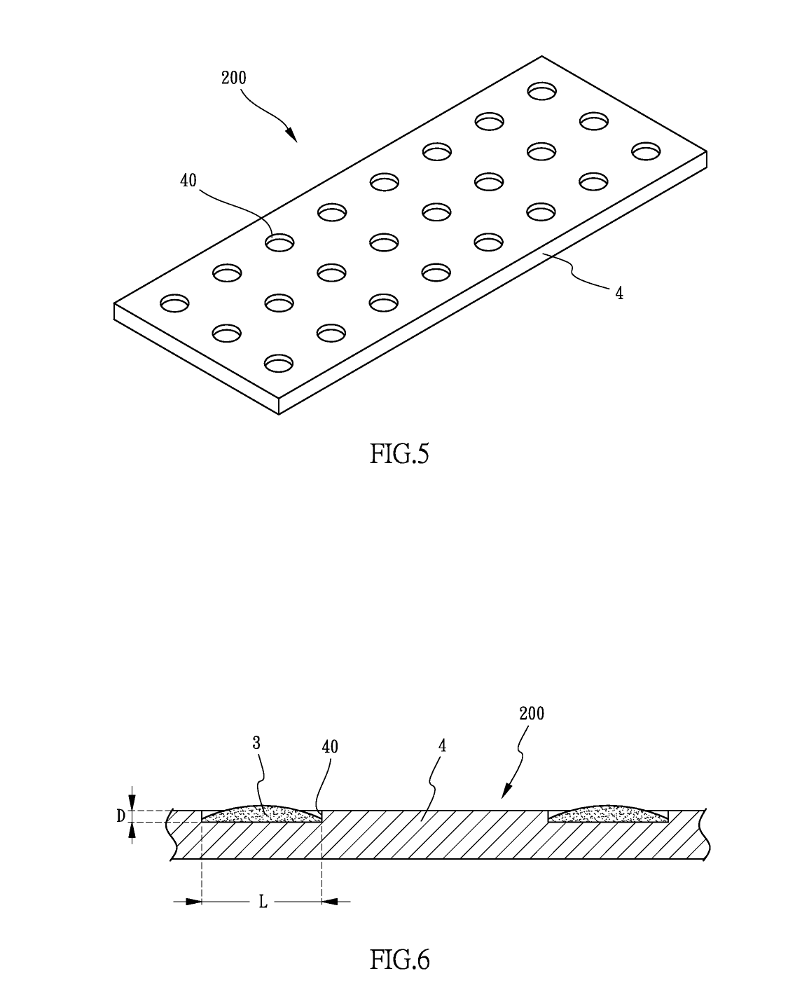

In the modification shown in FIGS. 5 and 6, the multi-well plate 200 has a substrate 4 that is made of metal, rather than a light transmissive material. Thus, the aforementioned metallic layer 2 may be excluded as in this example (or a SERS active layer as in other examples, not shown). The metal substrate 4 itself can reflect and diffuse the light for Raman scattering. Similar to the wells 10 in the substrate 1 shown in FIG. 2, the wells 40 in the substrate 4 have the same diameter of about 0.02 to 10 mm to receive the droplet of analyte, as shown in FIG. 6. The metal material for the substrate 4 may be aluminum or stainless steel, which is commercially available and relatively inexpensive.

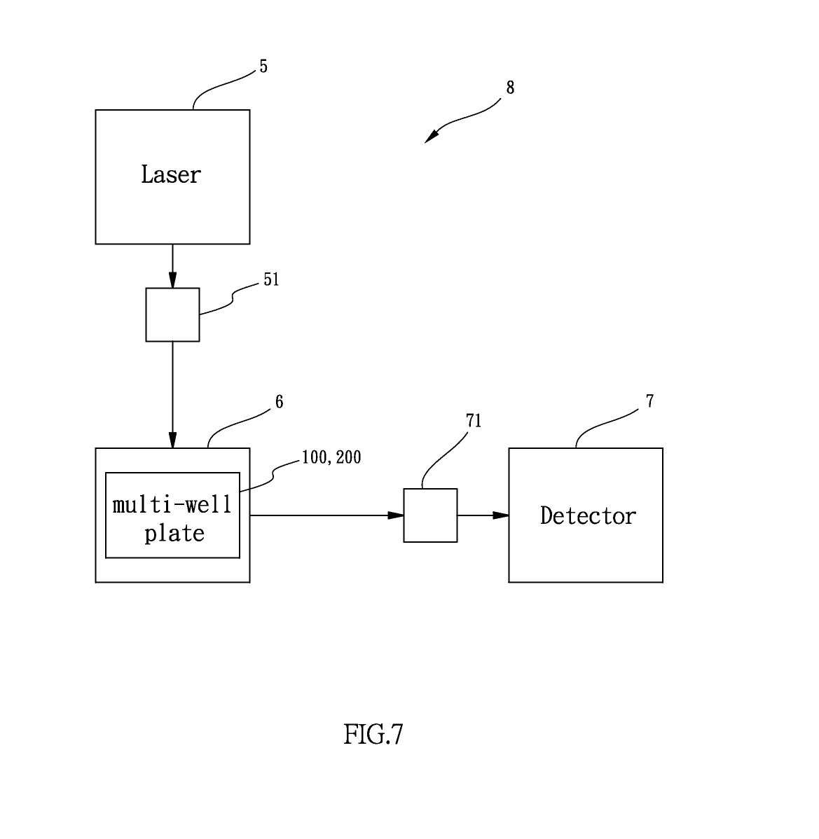

FIG. 7 is a block diagram schematically illustrating a Raman spectroscopy measurement system 8 which employs the aforementioned multi-well plate 100 or 200. Specifically, the Raman spectroscopy measurement system 8 mainly includes a laser light source 5, a stage 6, said multi-well plate 100 or 200 placed on the stage 6, and a detector 7.

The laser light source 5 is configured to irradiate light onto the analyte 3 located in one of the wells of the multi-well plate 100 or 200. The detector 7 is configured to receive Raman-scattered light scattered by the analyte 3. The Raman spectroscopy measurement system 8 also may include various optical components 51 positioned between the laser light source 5 and the stage 6, and various optical components 71 positioned between the stage 6 and the detector 7.

Furthermore, the laser light source 5 may be capable of emitting a tunable wavelength of radiation. The wavelengths that are emitted by the laser light source 5 may be any suitable wavelength for properly analyzing the analyte 3. An exemplary range of wavelengths that may be emitted by the laser light source 5 includes wavelengths between about 350 nm and about 1064 nm. The excitation radiation emitted by the laser light source 5 may be delivered either directly from the laser light source 5 to the multi-well plate 100 or 200 on the stage 6. Alternatively, collimation, filtration, and subsequent focusing of the excitation radiation may be performed by optical components 51 before the excitation radiation impinges on the multi-well plate 100 or 200 on the stage 161. It is noted that the multi-well plate 100 or 200 on the stage 6 may enhance the Raman signal of the analyte, as discussed previously herein.

The Raman scattered photons may be collimated, filtered, or focused with optical components 71. For example, a filter or a plurality of filters may be employed, either as part of the structure of the detector 7, or as a separate unit that is configured to filter the wavelength of the excitation radiation, thus allowing only the Raman scattered photons to be received by the detector 7.

The detector 164 receives and detects the Raman scattered photons and may include a monochromator (or any other suitable device for determining the wavelength of the Raman scattered photons) and a device such as, for example, a photomultiplier for determining the quantity of Raman scattered photons (intensity).

To perform SERS using the Raman spectroscopy measurement system 8, the analytes 3 in the wells of the multi-well plate 100 or 200 are irradiated one after another with excitation radiation or light from the laser light source 5. Raman scattered photons scattered by each of the analytes 3 are then detected by the detector 7.

What is claimed is:

1. A multi-well plate for use in Raman spectroscopy, comprising:
a substrate defining a plurality of wells therein; and
a metallic layer disposed on a bottom wall of each of the wells in the substrate.

2. A multi-well plate as recited in claim 1, wherein the substrate comprises a material selected from the group consisting of glass and plastic.

3. A multi-well plate as recited in claim 2, wherein each of the wells is recessed from a top surface of the substrate and into the substrate.

4. A multi-well plate as recited in claim 3, wherein each of the wells in the substrate has a diameter of about 0.02 to 10 mm and a depth of about 0.1 to 5 mm above the metallic layer for reception of about a droplet of an analyte.

5. A multi-well plate as recited in claim 4, wherein the metallic layer is SERS-active.

6. A multi-well plate as recited in claim 2, wherein the metallic layer is a SERS-active layer that comprises an array of nanostructures thereon.

7. A multi-well plate as recited in claim 2, wherein the metallic layer comprises a transition metal.

8. A multi-well plate as recited in claim 7, wherein the transition metal is selected from the group consisting of chromium, cadmium, iron, gold, silver, copper and nickel.

9. A multi-well plate as recited in claim 2, wherein the metallic layer comprises a metal selected from the group consisting of aluminum, stainless steel, copper, chromium and iron.

10. A multi-well plate as recited in claim 9, wherein the metallic layer is deposited on the bottom wall of each of the wells in the substrate.

11. A multi-well plate as recited in claim 9, wherein the metallic layer is electroplated on the bottom wall of each of the wells in the substrate.

12. A multi-well plate as recited in claim 9, wherein the metallic layer is a piece of metal sheet detachably positioned on the bottom wall of each of the wells in the substrate.

13. A multi-well plate for use in Raman spectroscopy, comprising a substrate defining a plurality of wells in a top surface thereof, wherein the substrate is made of metal, and each of the wells in the substrate has a diameter of about 0.02 to 10 mm and a depth of about 0.1 to 5 mm for reception of about a droplet of an analyte.

14. A multi-well plate as recited in claim 13, wherein the substrate comprises a metal selected from the group consisting of aluminum, stainless steel, copper, chromium and iron.

15. A Raman spectroscopy measurement system, comprising:
a multi-well plate including a substrate with a plurality of wells therein, and a metallic layer disposed on a bottom wall of each of the wells in the substrate;
a light source configured to irradiate light onto an analyte located in one of the wells of the multi-well plate; and
a detector configured to receive Raman-scattered light scattered by the analyte.

16. A Raman spectroscopy measurement system as recited in claim 15, wherein the substrate comprises a material selected from the group consisting of glass and plastic.

17. A Raman spectroscopy measurement system as recited in claim 16, wherein each of the wells in the substrate has a diameter of about 0.02 to 10 mm and a depth of about 0.1 to 5 mm for reception of about a droplet of the analyte on the metallic layer.

18. A Raman spectroscopy measurement system as recited in claim 16, wherein the metallic layer is a SERS-active layer that comprises an array of nanostructures thereon.

19. A Raman spectroscopy measurement system as recited in claim 16, wherein the metallic layer comprises a metal selected from the group consisting of aluminum and stainless steel.

20. A Raman spectroscopy measurement system as recited in claim 16, wherein the metallic layer is deposited or electroplated on the bottom wall of each of the wells in the substrate.
